(19) United States
(12) Patent Application Publication
(10) Pub. No.: US 2012/0102673 A1
(43) Pub. Date: May 3, 2012

(54) HANDLE GRIP

(75) Inventor: Mao-Hsiu Wang, Taichung County (TW)

(73) Assignee: HIGH CEDAR ENTERPRISE CO., LTD., Taichung County (TW)

(21) Appl. No.: 12/979,207

(22) Filed: Dec. 27, 2010

(30) Foreign Application Priority Data
Oct. 29, 2010 (TW) 99221027

(51) Int. Cl. B25G 1/00

(52) U.S. Cl. 16/110.1

(57) ABSTRACT

A handle grip includes a rubber tube member and a rubber lid. The tube member has a securing portion at an outer side, adjacent to an end thereof. The lid has a locking portion at an inner side thereof. The lid is firmly fitted to the end of the tube member by the locking portion engaging with the securing portion that, the lid will not be separated from the tube member even when a large force is applied on the lid.

### BACKGROUND OF THE INVENTION

1. Field of the Invention

The present invention relates generally to a racket or shaft, and more particularly, to a handle grip of the racquet or shaft.

2. Description of the Related Art

FIG. 1 shows a conventional handle grip 1 for a racquet (not shown), including a tube member 2, and a lid 3. The tube member 2 has a narrow end 2a, a wide end 2b, and a grip belt 4, which is wrapped around the tube member 2 that player may hold the handle grip 1 tightly. The lid 3 is fitted to the narrow end 2a of the tube member 2 to cover one end of the grip belt 4. To mount the handle grip 1 to a handle 5 of the racket, the lid 3 is fitted to the narrow end 2a of the tube member 2 first, and then a hole 2c of the tube member 2 will be expanded, the lid 3 is expanded at the same time, to insert a tail end 5a of the handle 5, into tube member 2.

The tube member 2 and the lid 3 are two elements just fitted together without any secure mechanism that, the lid 3 may escape from the tube member 2 before they are mounted to the handle 5 that, worker has to make sure that the lid 3 is fitted to the tube member 2 every time before the mounting job. This slows down the mounting job. In addition, the lid 3 will be tilted when the handle 5 is inserted into the tube member 2 that, the handle grip 1 may look strange. For a tight connection, an inner diameter of the tube member 2, is usually smaller than the handle 5. However, the handle 5 is inserted into the tube member 2 via the narrow end 2a that, the narrow end 2a usually is drawn inwardly by the handle 5 (shown as the dotted lines in FIG. 1). As a result, the conventional handle grip 1 needs to be improved.

### SUMMARY OF THE INVENTION

The primary objective of the present invention is to provide an idler adjusting apparatus of an exercise machine, which provides an easy way for user to adjust the idler at home.

According to the objective of the present invention, a handle grip includes a tube member having at least a securing portion on the surface of the tube, and adjacent to an end thereof; and a lid having at least a locking portion on an inner side thereof. The lid is fitted to the end of the tube member when the locking portion engages with the securing portion.

In an embodiment, the securing portion of the tube member is a slot, and the locking portion of the lid is a protrusion to be engaged with the slot.

### BRIEF DESCRIPTION OF THE DRAWINGS

FIG. 1 is a sectional view of the conventional handle grip;

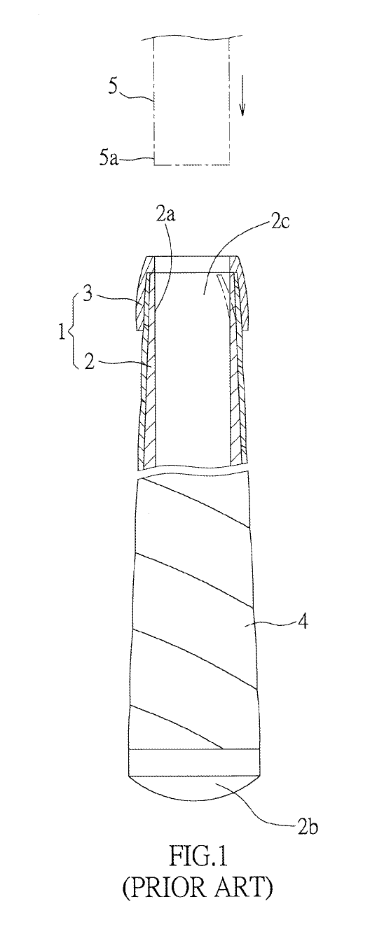

FIG. 2 is a perspective view of a first preferred embodiment of the present invention;

FIG. 3 is a sectional view of the first preferred embodiment of the present invention, showing the grip belt wrapped around the tube member;

FIG. 4 is a sectional view of a second preferred embodiment of the present invention, showing the opening of the lid is smaller than the entrance of the hole of the tube member;

FIG. 5 is a perspective view of a third preferred embodiment of the present invention; and

FIG. 6 is a sectional view of the third preferred embodiment of the present invention, showing the grip belt wrapped around the tube member.

### DETAILED DESCRIPTION OF THE INVENTION

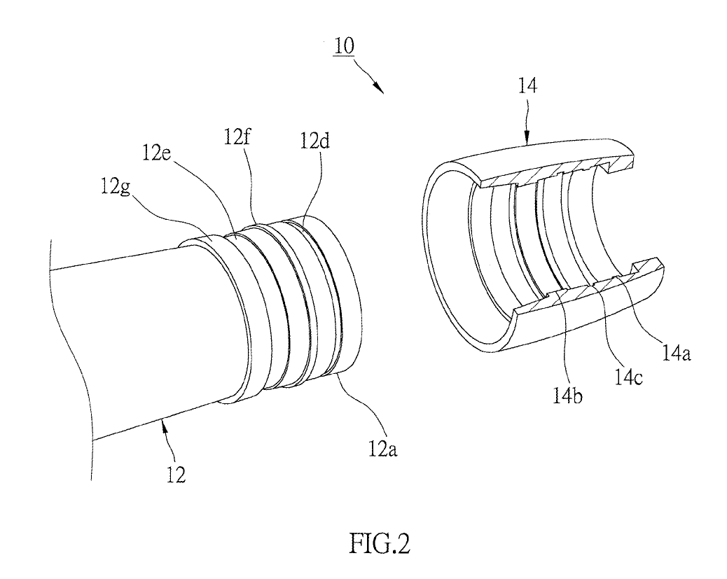

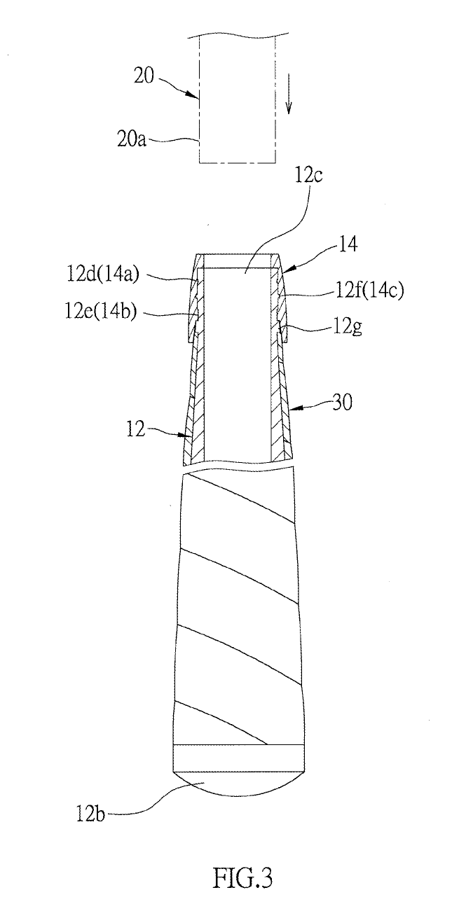

As shown in FIG. 2 and FIG. 3, a handle grip 10 of the preferred embodiment of the present invention is mounted on a handle 20 of a tennis racket, badminton racket, golf club shaft, and other relative rackets or shafts. The handle grip 10 includes a tube member 12 and a lid 14, both of which are made of rubber.

The tube member 12 has a narrow end 12a, a wide end 12b and an entrance of a hole 12c of the tube member 12, is defined at the narrow end 12a. At an outer side of the tube member 12, two slots 12d and 12e, are adjacent to the narrow end 12a, and a protrusion 12f between the slots 12d and 12e, to form a locking portion. The tube member 12 further has a protrusion 12g next to the slot 12e. The protrusion 12g stops a grip belt 30 wrapped around the tube member 12 that, the grip belt 30 will never cover the slot 12e.

The lid 14 is a ring member fitted to the narrow end 12a of the tube member 12. The lid 14 has two protrusions 14a, 14b, and a slot 14c between the protrusions 14a, 14b, to form a locking portion. The protrusion 14a is engaged with the slot 12d of the tube member 12, the protrusion 14b is engaged with the slot 12e, and the slot 14c is engaged with the protrusion 12f that, the lid 14 is firmly fixed to the tube member 12. In our test, the lid 14 will not be disengaged with the tube member 12 even when a large force is applied to the lid 14. The engagement of the lid 14 and the tube member 12 will not allow a tilt of the lid 14, as well that the lid 14 may always be kept in straight position when the handle 20 is inserted into the tube member 12.

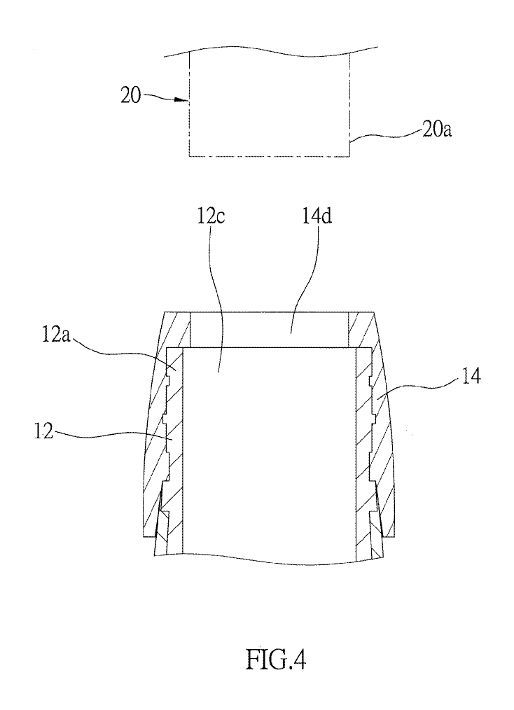

FIG. 4 shows the second preferred embodiment of the present invention, in which the lid 14 has an opening 14d at a top thereof, and the opening 14d is smaller than the entrance of the hole 12c of the tube member 12. It may prevent the narrow end 12a of the tube member 12 from being drawn inwardly by the handle 20.

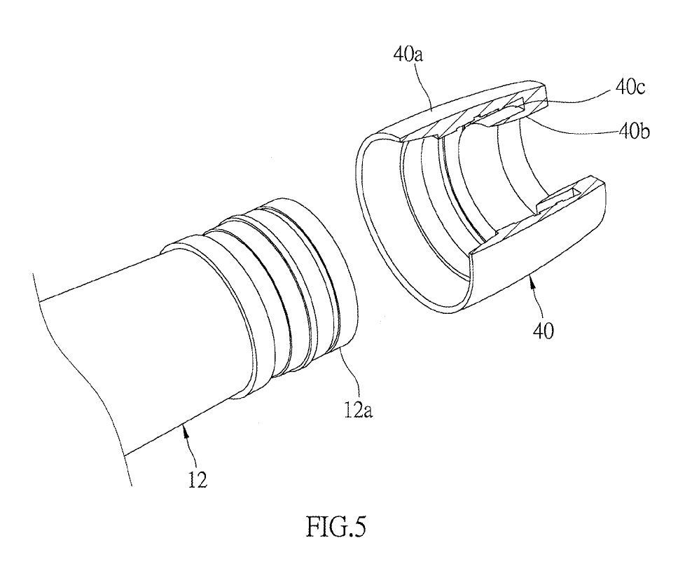

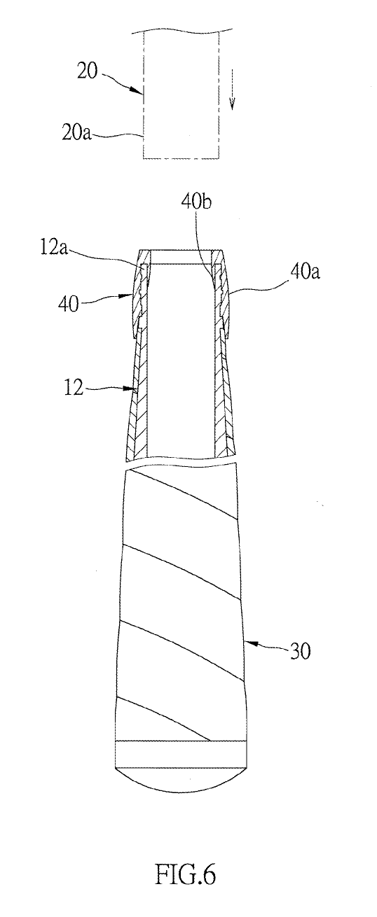

FIG. 5 and FIG. 6 is the third preferred embodiment of the present invention which provides another structure to prevent the narrow end 12a of the tube member 12, from being drawn inwardly by the handle 20.

A sidewall of a lid 40 of the third preferred embodiment is constructed of an outer piece 40a, and an inner piece 40b, having a top end connected to a top end of the outer piece 40a that, a gap 40c is formed between the outer piece 40a, and the inner piece 40b. The outer piece 40a is longer than the inner piece 40b. The narrow end 12a of the tube member 12 is inserted into the gap 40c of the lid 40. With this structure, the narrow end 12a of the tube member 12 is isolated from the handle 20 by the inner piece 40b that, the narrow end 12a will never be drawn by the handle 20.

A free end of the outer piece 40a, is thinner than the rest to keep the handle grip having a constant diameter when the grip belt 30 is wrapped around the tube member 12 and, the free end of the outer piece 40a covers the grip belt 30. The same characteristics may be applied to the lid 14 of the first preferred embodiment.

The description above is a few preferred embodiments of the present invention and the equivalence of the present invention is still in the scope of claim construction of the present invention.

What is claimed is:

1. A handle grip, comprising:
a tube member having at least a securing portion at an outer side, adjacent to an end thereof; and
a lid having at least a locking portion at an inner side thereof that the lid is fitted to the end of the tube member by the locking portion engaged with the securing portion.

2. The handle grip as defined in claim 1, wherein the securing portion of the tube member and the locking portion of the lid are a slot and a protrusion for engagement.

3. The handle grip as defined in claim 1, wherein the tube member further has a protrusion next to the securing portion.

4. The handle grip as defined in claim 1, wherein the lid has an opening which is smaller than an entrance of a hole of the tube member.

5. The handle grip as defined in claim 1, wherein the lid has an outer piece and an inner piece; having a top end connected to a top end of the outer piece that a gap is formed between the outer piece and the inner piece, and the end of the tube member is inserted into the gap of the lid.

6. The handle grip as defined in claim 5, wherein a free end of the outer piece is thinner than the rest of the outer piece.
